(19) United States
(12) Patent Application Publication
(10) Pub. No.: US 2005/0135023 A1
(43) Pub. Date: Jun. 23, 2005

(54) Programmable digital power controller

(75) Inventors: Dimitry Goder, San Jose, CA (US); William Robert Pelletier, San Jose, CA (US)

Correspondence Address: FLIESLER MEYER, LLP, FOUR EMBARCADERO CENTER, SUITE 400, SAN FRANCISCO, CA, 94111, US

(73) Assignee: Sipex Corporation, Milpitas, CA (US)

(21) Appl. No.: 10/742,182

(22) Filed: Dec. 19, 2003

(51) Int. Cl. H02H 7/00

(52) U.S. Cl. 361/18

(57) ABSTRACT

A digital power control device implemented on an integrated circuit includes analog to digital conversion circuitry configured to generate a digital signal from a received analog signal regulator, circuitry connectively coupled to the analog to digital conversion circuitry, the regulator circuitry configured to receive the digital signal and generate a digital duty cycle information signal, a plurality of pulse width modulation signal generators, each pulse width modulation signal generator configured to receive the digital duty cycle information signal and generate a high pulse width modulation signal and a low pulse width modulation signal, and control circuitry connectively coupled to and configured to control the plurality of pulse width modulation signal generators. The power controller processes digital signals to generate multiple PWM signals through a vertical integration of power controller modules. The power controller is designed to programmable and flexible. As a result, the power controller of the present invention can be used for unlimited numbers of applications and consumer products having diverse power needs. Protection and monitoring circuitry can be configured by a user to retrieve information from the power controller as well as manage its operation. PWM signals are generated from switching frequency signals and a plurality of clock signals, along with an array of digital circuitry for specifying FET switching stage signal characteristics.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to power controllers, and more particularly to programmable digital power controllers.

### BACKGROUND OF THE INVENTION

Power controllers are designed to provide power to a wide variety of electronic devices. Typically, a power controller is used in conjunction with other components in stages to satisfy a particular power requirement for a system.

A typical power regulating system for providing a power signal Vout is illustrated in FIG. 1. System 100 includes power controller 110, driver stage 120, switch/FET stage 130, and LC filter stage 140. The power controller provides a high and low pulse width modulation (PWM) signal to a driver stage. The driver stage typically includes a driver 121 for the high PWM signal and a driver 122 for the low PWM signal. The output signals of the driver stage 120 are provided to a switching stage 130. A switching stage receives the driven high and low PWM signals and generates a switching frequency signal, f_{sw}. In FIG. 1, the high PWM signal and low PWM signal are each applied to the gate of a FET. The FET pair produce a switching signal f_{sw}, that is received by an LC filter stage 140. The LC filter stage generates an output voltage signal, Vₒᵤₜ.

As semiconductor technology has developed and provided for faster and smaller integrated circuits (IC), more sophisticated IC components are utilized in electronic devices. As a result, many electronic devices have several IC components, many having different and specific power requirements. Additionally, the power supply for more sophisticated devices provides power for numerous integrated circuits and many device functions. Power in these devices, especially mobile computing devices, is a valuable commodity. Many devices incorporate power saving functions such as standby mode, sleep mode, reduced power mode, etc. Thus, the power supply characteristics for modern devices include power requirements for an increasing number of ICs along with varying power output levels for reducing power consumption.

Power regulation system 100 of FIG. 1 provides a single power signal Vout. For devices having multiple components having differing power specifications, system 100 will not suffice. In most electrical devices having multiple ICs, a series of power control components is provided to meet each power requirement.

FIG. 2 illustrates a system 200 of the prior art that provides multiple power signals. System 200 includes power component group (PCG) 240, which includes multiple sets of power components from the power controller to the LC filter stage, each providing a Vout signal. Typically, for devices with multiple power requirements in the prior art, systems provide a power controller, driver, switch and LC filter, as shown in power component group (PCG) 244, to meet each power requirement.

Some elements of a PCG are provided together in groups. For example, some IC manufacturers provide a power controller, a driving stage, a switching stage, and an LC filter on an IC to be used within a device, as shown by PCG 244. Alternatively, the LC filter may be implemented as a module that this in communication with the switching stage and not part of the IC itself. Other combinations include a power controller, driver, and switching stage such as in group 242, or a power controller and driver as in group 240. For each of these groups, one group is used for each required power signal and complemented with additionally components and stages as needed.

There are several disadvantages to the power control systems of the prior art. ICs having grouped power control elements-require additional space on printed circuit boards. This can be crucial when devices implement numerous ICs and space is limited. When multiple power controller group ICs are placed on a PCB, several issues must be worked out between the groups, such as cross talk and noise from clock signals and capacitive coupling between channels in multiplexers. In the case where an IC includes a plurality of groups, such as a plurality of group 244 or group 242 on the same IC, placement of the IC on the PCB is an issue because the Vout signals will not always be placed near the required source. Further, an IC with a plurality of groups may be manufactured for a specific device, but such an IC is generally not flexible nor programmable in the output power specifications it can provide.

What is needed is a flexible, programmable, digital power controller that overcomes the shortcomings and disadvantages of the prior art.

### SUMMARY OF THE INVENTION

In one embodiment, the power controller of the present invention processes digital signals to generate multiple PWM signals. The power controller is implements a vertical integration of power controllers. The power controller of the present invention is designed to programmable and flexible. As a result, the power controller of the present invention can be used for unlimited numbers of applications and consumer products having diverse power needs. The digital power controller includes protection and monitoring circuitry that can be configured by a user to retrieve information from the power controller as well as manage its operation. In one embodiment, PWM signals are generated from switching frequency signals and a plurality of clock signals, along with an array of digital circuitry for specifying FET switching stage signal characteristics.

### BRIEF DESCRIPTION OF THE DRAWINGS

FIG. 1 is an illustration of a power regulating system for providing a power signal according to the prior art.

FIG. 2 is an illustration of a power regulating system for providing multiple power signals according to the prior art.

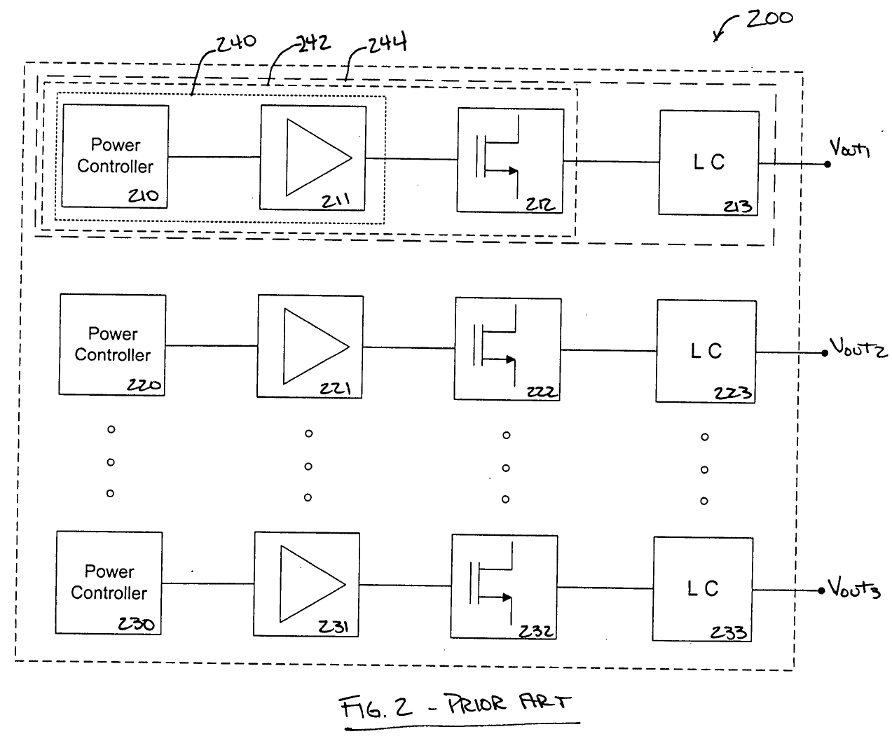

FIG. 3 is an illustration of a power regulating system for providing multiple power signals in accordance with one embodiment of the present invention.

FIG. 4 is an illustration of a block diagram of a digital power controller in accordance with one embodiment of the present invention.

FIG. 5 is an illustration of a block diagram of a PID regulator in accordance with one embodiment of the present invention.

FIG. 6 is an illustration of a block diagram of a PWM system in accordance with one embodiment of the present invention.

FIG. 7 is an illustration of the timing relation of four PLL output signals in accordance with one embodiment of the present invention.

FIG. 8 is an illustration of a block diagram of a synchronization system in accordance with one embodiment of the present invention.

FIG. 9 is an illustration of a block diagram of a duty cycle controller in accordance with one embodiment of the present invention.

FIG. 10 is an illustration of a block diagram of a PWM generator in accordance with one embodiment of the present invention.

FIG. 11 is an illustration of a PWM signal timing diagram in accordance with one embodiment of the present invention.

FIG. 12 is an illustration of a block diagram of a over-current protection system in accordance with one embodiment of the present invention.

FIG. 13 is an illustration of an implementation of a digital power controller integrated circuit in accordance with one embodiment of the present invention.

### DETAILED DESCRIPTION

In one embodiment, the power controller of the present invention processes digital signals to generate multiple PWM signals. The power controller is implements a vertical integration of power controllers. The power controller of the present invention is designed to be programmable and flexible. As a result, the power controller of the present invention can be used for unlimited numbers of applications and consumer products having diverse power needs. The digital power controller includes protection and monitoring circuitry that can be configured by a user to retrieve information from the power controller as well as manage its operation. In one embodiment, PWM signals are generated from switching frequency signals and a plurality of clock signals, along with an array of digital circuitry for specifying FET switching stage signal characteristics.

Vertical Integration

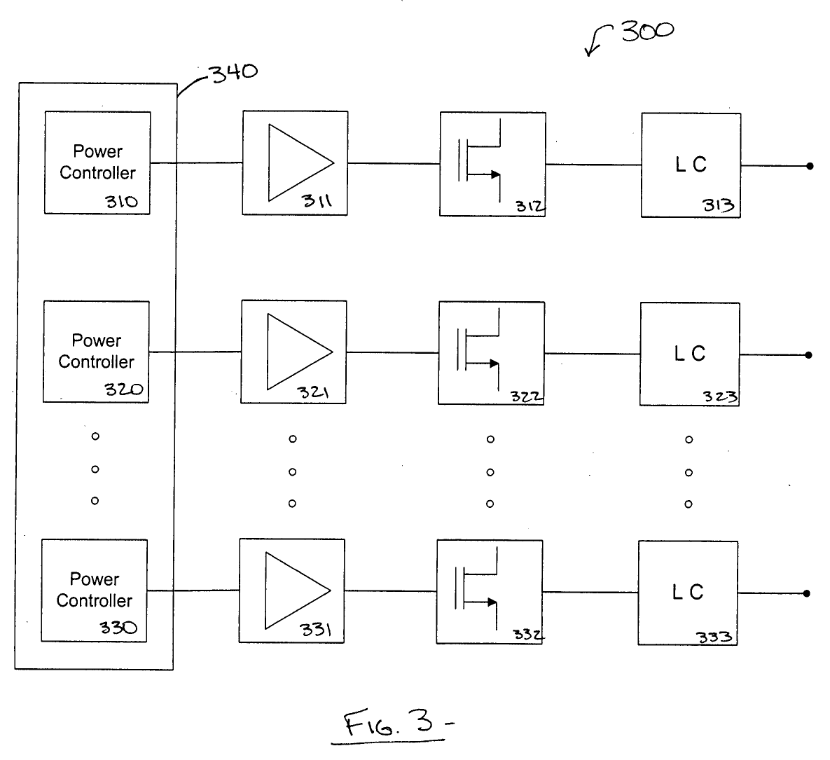

A power regulating system 300 in accordance with one embodiment of the present invention is illustrated in FIG. 3. System 300 includes power controllers 310, 320 and 330, driver stages 311, 321, and 331, FET stages 312, 322, and 332, and LC filter stages 313, 323, and 333. Unlike systems of the prior art, the present invention utilizes a vertical integration to provide power regulation. In this respect, the present invention includes a plurality of power controllers on a single integrated circuit. Thus, as indicated by group 340, the present invention may include power controllers 310, 320, and optionally additional power controllers up to power controller 330. Driving stages, FETs, and filters are not included in the power regulator of the present invention. By providing multiple power controllers, the system of the present invention may control the power needs of an entire system, such as a laptop or desktop computer, cell phone, personal digital assistant (PDA), notebook computer, radio, stereo system, and other electronic devices. By separating the driving, switching, and filter stage from the power controller, all the intelligence in a power regulation system can be handled by the multiple power controller device of the present invention. No decision or monitoring circuitry needs to be implemented in the stages after the power controlling stage. Additionally, a single analog to digital converter, serial interface, and memory system may be implemented for use with the plurality of power controllers. This saves power, processing time, and space compared to systems of the prior art. Additional advantages and implementation details regarding vertical integration of a power controllers in accordance with one embodiment of the present invention are discussed below.

Digital Implementation

In one embodiment of the present invention, signal generation and management is handled digitally. Unlike power controllers of the prior art, signals can be generated and processed much more quickly and precisely. For example, a duty cycle signal and multiple load signals can be generated very precisely in the digital domain as compared to the analog domain. This is advantageous for a system that has several power pattern requirements. Additional advantages and implementation details regarding the digital implementation of the power controller in accordance with one embodiment of the present invention are discussed below.

Programmability

The power controller of the present invention is programmable. In one embodiment, the power controller of the present invention may be programmed by the manufacturer to satisfy a broad range of power requirements for a system. The programmability aspect provides for a flexible IC solution that can be integrated into many systems having diverse power needs. In one embodiment, the programmability is implemented using a programmable memory device. The memory device may be an EEPROM device, FLASH or some other type of device. The memory device may have 128 bits of memory, 256 bits, or some other memory size. As discussed in more detail below, the memory may be accessed by the manufacturer, by the system, or internally by the power controller itself. Though the memory device may be discussed in terms of a certain type of memory, such as an EEPROM, the scope of the present invention is intended to cover other types of memory, including RAM, FLASH, and other programmable memory.

In one embodiment, in addition to the EEPROM, the power controller system includes control circuitry. The control circuitry can be configured as a state machine or some other type of control circuitry. The state machine may perform read and write operations to the memory device. The state machine may be implemented as a programmable device, such as an ASIC, or may be hardwired. Additional advantages and implementation details regarding the programmability of the power controller in accordance with one embodiment of the present invention are discussed below.

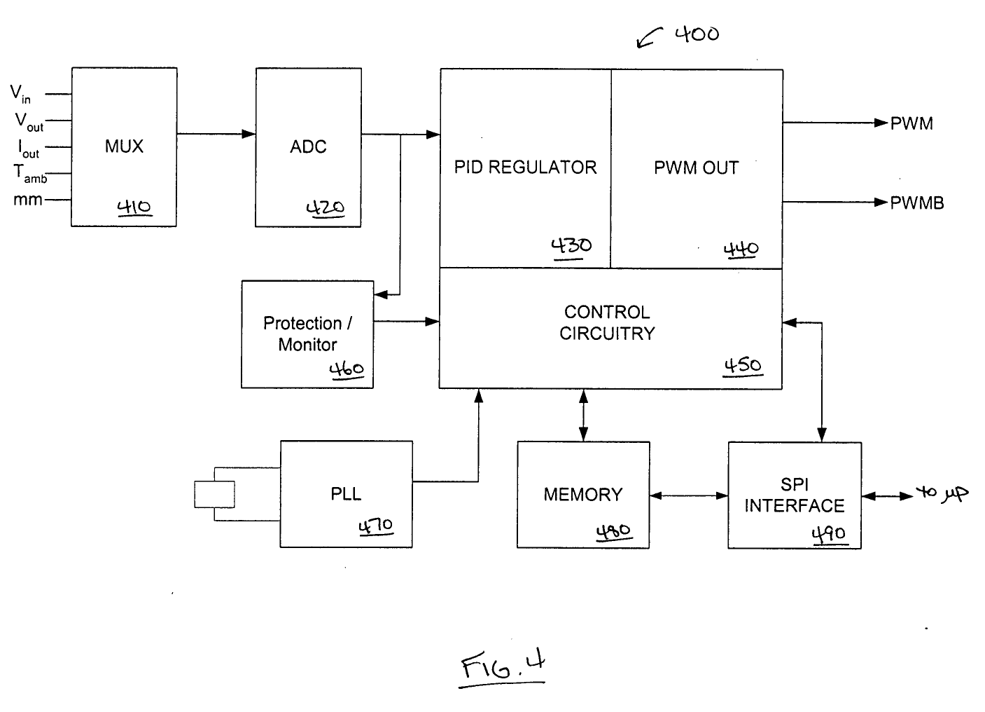

FIG. 4 illustrates a block diagram of a digital power controller 400 in accordance with one embodiment of the present invention. Digital power controller 400 includes a multiplexer (MUX) 410, an analog to digital converter (ADC) 420, a PID Regulator 430, a pulse width modulation (PWM) out module 440, control circuitry 450, protection and monitor circuitry 460, phase locked loop circuitry 470, memory 480, and an serial port interface 490.

In one embodiment, MUX 410 receives a plurality of signals and provides a signal to the ADC for processing. The MUX selection signals may be controlled by controlling circuitry 450 (not shown in FIG. 4). The signals received by the MUX that may be selected include Vin, Vout, lout, Tamb, and mm. The conditions for which each signal are selected and processed are discussed in more detail below.

In one embodiment, the ADC 420 receives an analog signal from the MUX and converts it to a digital signal. The ADC digital output may be provided to the PID regulator as illustrated. Protection and Monitoring circuitry 460 may also receive the ADC digital output signal. As illustrated in FIG. 4, the use of a single ADC for a plurality of PMW signal generators allows for reduced signal processing, power consumption, and space used in the vertically integrated digital power controller of the present invention. The ADC may be chosen to provide adequate conversion for analog signals received by MUX 410. In one embodiment, the ADC may be a ten bit ADC.

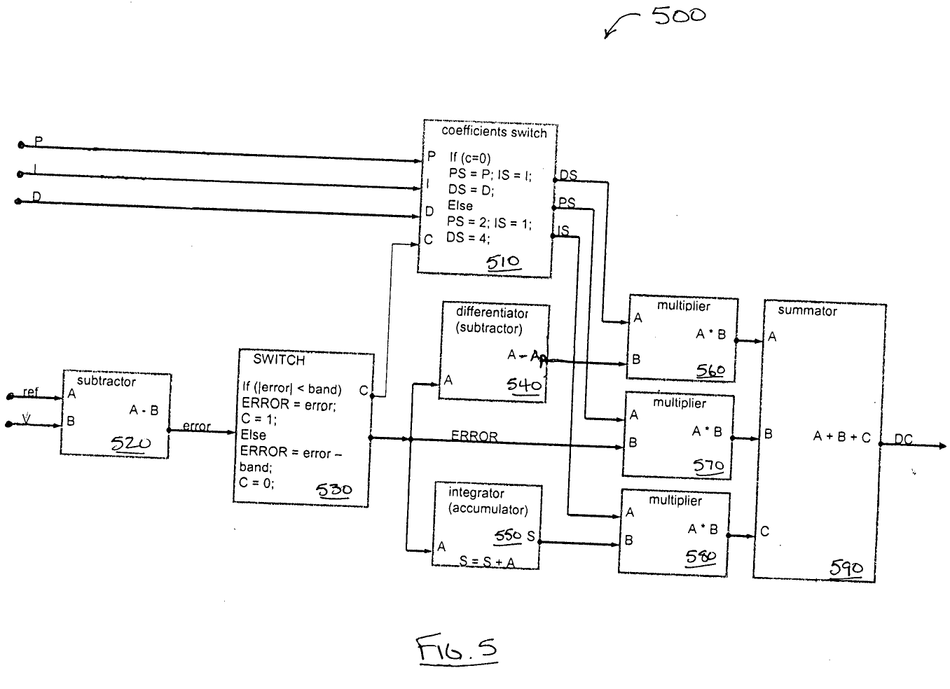

The PID regulator receives input signals, processes the signals using digital circuitry, and generates a duty cycle signal. In one embodiment, the PID regulator receives a digitized output voltage signal from the ADC and several signals generated internally. A block diagram of a PID regulator 500 in accordance with one embodiment of the present invention is illustrated in FIG. 5. PID Regulator 500 includes coefficients switch 510, subtractor 520, switch 530, differentiator 540, integrator 550, multipliers 560, 570 and 580, and summator 590. The components of the PID regulator can be driven by a clock signal which is not shown for purposes of simplifying the illustration. In operation, coefficient switch 510 receives a proportional (P), integral (I) and derivative (D) signal. The P, I and D signals are generated by the control circuitry. In one embodiment, values for the P, I, and D signal may be derived from information programmed into the memory 480. In one embodiment, the derived values set in memory may be tunable. The output of the coefficient switch 510 is determined by the output of switch 530.

Subtractor 520 receives a reference signal and a voltage signal. In one embodiment, the reference signal is the target signal and the voltage signal is the Vout signal generated by the output of the LC filter. The Vout signal can be measured using resistors or some other sampling method as known in the art. The target signal may be received from a source external to the digital power controller or generated internally by the digital power controller. When generated internally, the value of the target signal may be derived from information stored in memory 480. Subtractor 520 subtracts the voltage signal from the reference signal to determine the difference between the desired voltage and the actual voltage. The generated difference signal, labeled “error” signal, is then received by switch 530.

Switch 530 operates to compare the “error” difference signal to a predetermined band. The embodiment illustrated in FIG. 5 implements a dual band control, wherein the “error” signal is processed based on a two-band range. If the “error” signal value lies in a first or lower band, the gain of the signal is lower. If the “error” signal value lies in a second or higher band, the gain of the signal is higher. Variations of this implementation are possible, wherein the range may include three or more bands. In dual band switch 530, based on the results of the comparison, values for an “ERROR” signal and coefficient control signal are generated and output. The band represents an acceptable difference between the measured voltage and the reference voltage. If the difference between the two voltages is larger than the band value, than the digital power controller implements a process to reduce the difference. In one embodiment, the value of the band is derived from information stored in memory 480. In another embodiment, the value of the band is derived from the control circuitry 450. In the embodiment shown in FIG. 5, if the “error” difference signal is larger than the band value, then the “ERROR” signal has a value corresponding to the difference between the “error” signal and the band and an enabling signal (in this case, a low signal) is sent to the coefficients switch. If the “error” difference signal is smaller than the band value, then the “ERROR” signal has a value corresponding to the “error” signal and a non-enabling signal (in this case, a high signal) is sent to the coefficients switch.

The “ERROR” signal generated by switch 530 is received by differentiator 540, integrator 550 and multiplier 570. Differentiator 540 generates a difference signal by subtracting the current value of the received “ERROR” signal from the previously received “ERROR” signal. The difference signal is then received by multiplier 560. Integrator 550 receives the “ERROR” signal and generates an accumulated “ERROR” signal, which is the sum of past error signals received. The accumulated error signal is then provided to multiplier 580.

The coefficient switch 510 is configured to provide different values to multipliers 56-580 depending on the value of the “error” signal. If the “error” signal value is greater than the band value, and the control signal provided to the coefficient switch 510 is low, the outputs are the same P, I and D signal received by the coefficient switch 510. In this case, each of the P, I and D signals are received by one of multipliers 560-580. If the “error” signal is less than the band value, and the control signal provided to the coefficients switch 510 is high, the outputs are predetermined multiplier values. In the embodiment illustrated in FIG., 5, the predetermined multiplier values are four for the DS signal, two for the PS signal, and one for the IS signal.

Each of multiplier 560-580 receives a signal derived from the “ERROR” signal generated from switch 530 and a PID signal generated from coefficients switch 510. The multipliers each multiply the signals together and output a product signal. Each of the product signals are received by summator 590. Summator 590 sums the signals and outputs a duty cycle information signal (DC). The duty cycle information signal provides information from which the duty cycle signal can be derived.

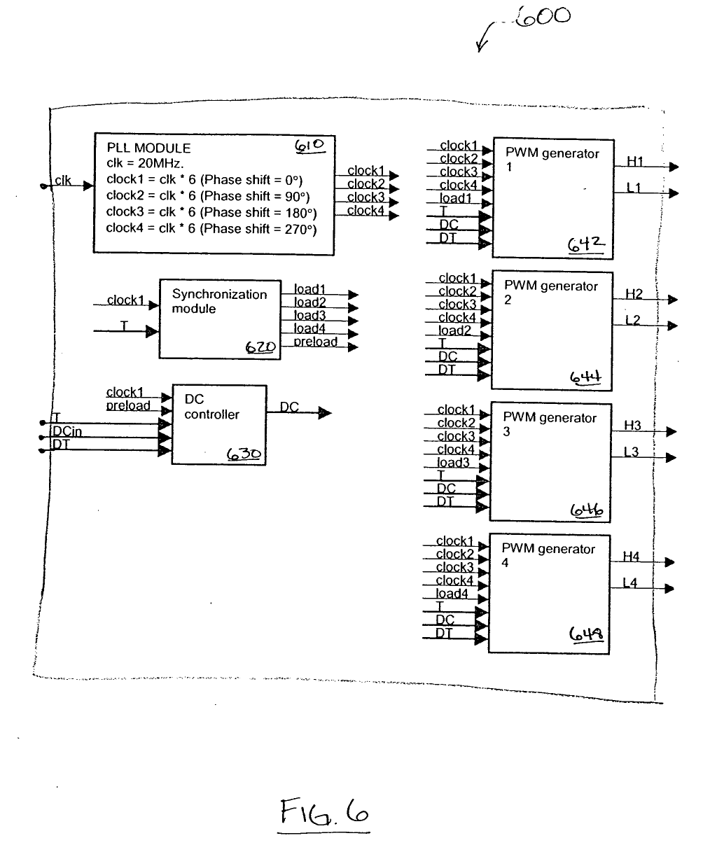

The PWM out module generates high and low pulse width modulation signals. A block diagram of a PWM system 600 is illustrated in FIG. 6. PWM system 600 includes a phase locked loop (PLL) module 610, synchronization module 620, DC Controller 630, and PWM generators 642-648. The PWM out module of FIG. 6 is an exemplary of a digital power controller having four outputs. More or fewer outputs could be configured for a digital power controller of the present invention, and are included in the scope of the present invention.

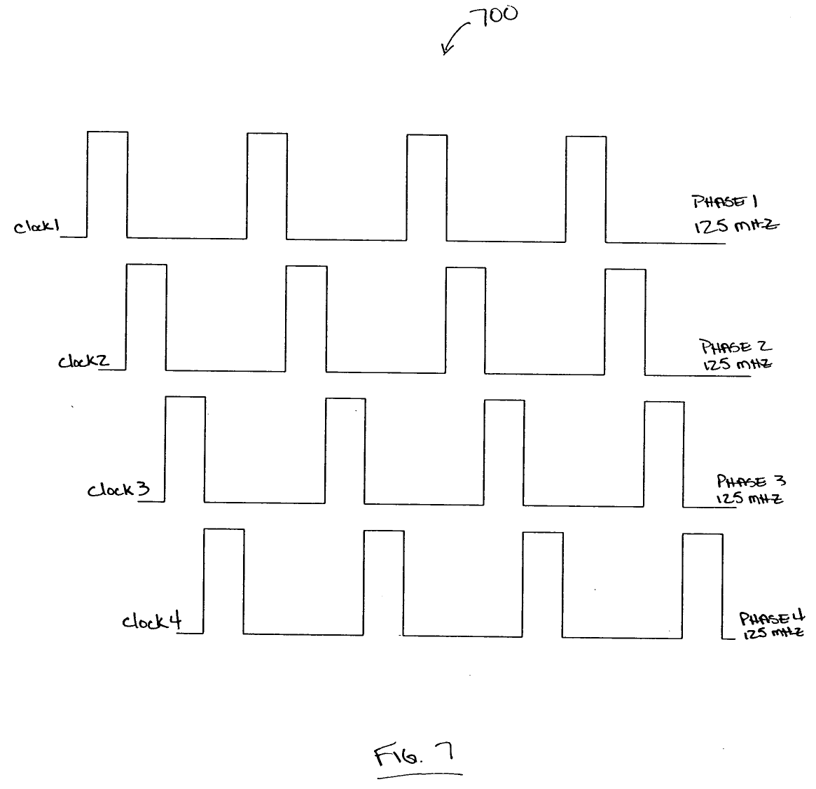

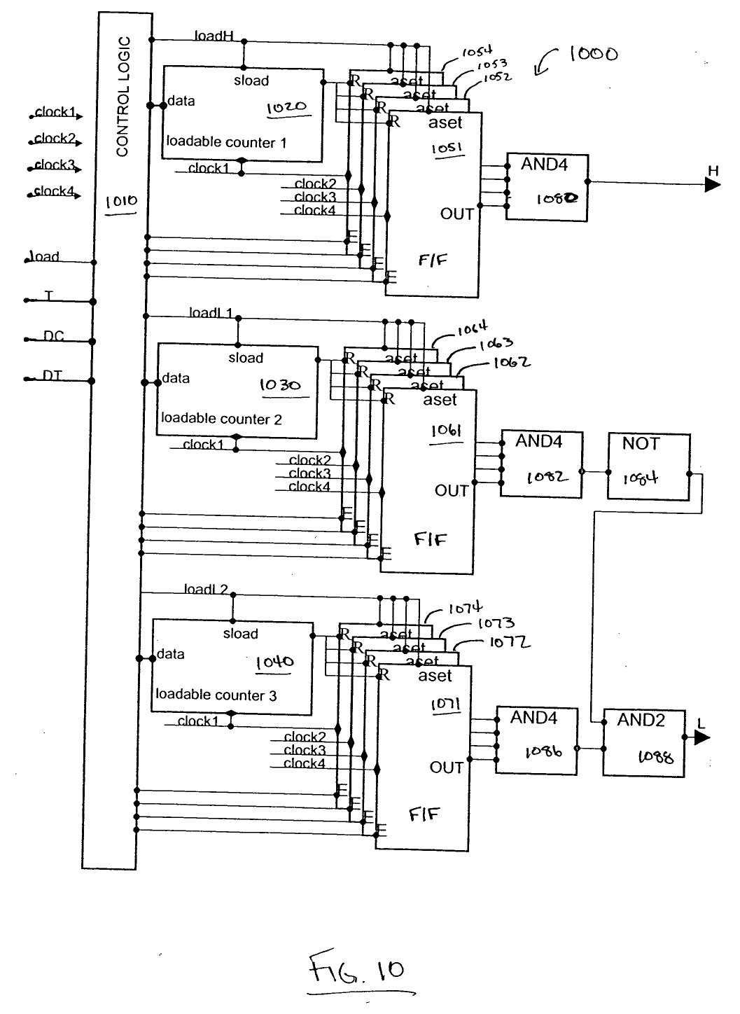

The PLL module 610 depicted in FIG. 6 may be implemented as PLLs commonly known in the art. Though the PLL is illustrated as residing outside the PWM out module in FIG. 4, the PLL can be implemented in a variety of ways. For purposes of illustration, the PLL will be discussed with respect to the PWM out module. The embodiment of FIG. 6 illustrates an implementation wherein four signals are desired, each having a phase shift of ninety degrees. The PLL module receives a clock signal of approximately 20 MHz. Four signals are generated, each having a frequency of the approximately 20 MHz clock multiplied by six, resulting in four 125 MHz signals. The phase shift of the signals is used to create a high resolution signal in the PWM Generator, discussed in more detail with reference to FIG. 10. FIG. 7 illustrates the timing relation of four PLL output signals in accordance with one embodiment of the present invention. As shown, each 125 MHz signal is ninety degrees out of phase. When the signals are added together, or used to latch flip flops as illustrated in FIG. 10, the resulting frequency is a high resolution 500 MHz.

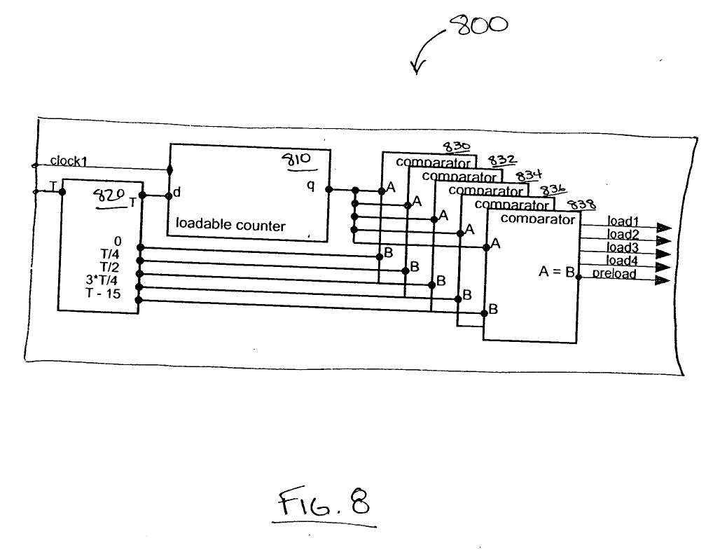

The synchronization module 620 of FIG. 6 operates to generate load signals for the PWM generators. Synchronization module 620 derives the load signals from the zero phase shifted clock signal and the shifting frequency signal. A block diagram of a synchronization system 800 is illustrated in FIG. 8. Synchronization system 800 includes counter 810, load value circuitry 820, and comparators 830, 832, 834, 836, and 838. In operation, the counter 810 is loaded with a number associated with the switching frequency signal. The counter 810 is driven by a clock signal from the PLL module 610. Comparators 830 through 838 compare the output of the counter with a value of the switching frequency, such as one fourth, one half, three quarters, and so forth. The values of the load value circuitry 820 may be programmed into memory 480 or derived from control circuitry 450. For each counter, when the output of the counter equals the corresponding load value derived from the switching frequency, the comparator provides a load signal. The load signals are then used in the PWM generators, as discussed with reference to FIG. 10.

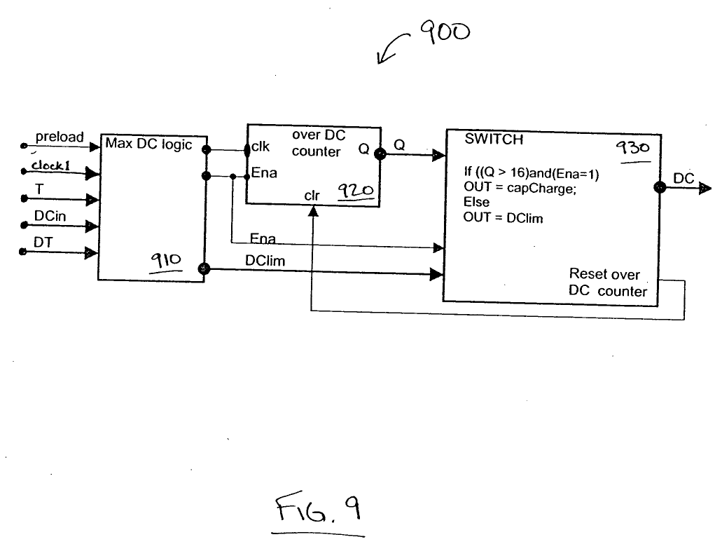

The DC controller 630 of FIG. 6 transforms a duty cycle information signal from the PID controller into a duty cycle signal. The duty cycle signal is scaled into the clock cycle using the duty cycle information signal. The number of clock signals that comprise the duty cycle depends on the switching frequency. A block diagram of a DC controller 900 in accordance with one embodiment of the present invention is illustrated in FIG. 9. DC controller 900 includes maximum DC logic 910, over-DC counter 920, and switch 930. In operation, the max DC logic 910 receives a preload signal, clock1 signal, switching frequency signal T, duty cycle information signal, and DT signal. The maximum DC logic receives the DCin number from the PID regulator and scales it into clock cycles. The number of clock cycles for a particular DCin number is dependent upon the switching frequency. For example, a fifty percent (50%) duty cycle is scaled to fifty percent of the switching frequency. In this case, if the switching frequency is 1 MHz, the maximum DC logic would count half of a microsecond counts of a duty cycle. If the switching frequency is 500 KHz, then a fifty percent DC would count one micro second. Thus, the PID regulator provides a scale quantity without knowing what the switching frequency is. The DC controller scales the DC signal to real clock time.

In one embodiment, in addition to generating the scaled real-clock time DC signal, the maximum DC controller monitors and limits the DC to a maximum value. In this embodiment, the DC is limited from exceeding one hundred percent (100%) of the switching frequency. In the embodiment shown in FIG. 9, over DC counter 920 counts the number of clock cycles that the DC is greater than one hundred percent of the switching frequency. If the DC is over 100% of the switching frequency for a threshold value of cycles, then an action is taken to correct the DC. In the embodiment shown, the threshold is sixteen cycles and the action is to stop the DC for a time corresponding to a capacitor charging. However, other threshold values could be used and other actions could be performed upon reaching the threshold, as will be understood by those skilled in the art. When the DC has not exceeded one hundred percent of the switching frequency for the threshold value number of cycles, the DC is output by switch 930.

In FIG. 6, the DC signal generated by the DC controller is received by each of the PWM Generators 642-648. A PWM Generator is used to generate a pair of high and low PWM signals. FIG. 10 illustrates a block diagram of a PWM generator in accordance with one embodiment of the present invention. PWM generator includes control logic 1010, loadable counters 1020, 1030 and 1040, three sets of four flip flops, flip flops 1051-1054, 1061-1064 and 1071-1074, AND gates 1080, 1082, 1086 and 1088, and NOT gate 1084. In operation, control logic receives a plurality of signals. In the embodiment illustrated, the signals include clock1-clock4, a load signal, the switching frequency T, the DC signal output from the DC controller, and the non-overlap signal DT. In one embodiment, the non-overlap signal DT provides information from which the non-overlap time of the PWM high and low signals can be derived. The non-overlap time is retrieved from memory 480, and can be programmed by a user or generated internally.

Each flip flop in each of the three sets of flip flops are driven by one of clock signals clock1-clock4. The flip flops are asynchronously reset, so that they reset on clock counts, and each set of flip flops is received by a corresponding AND gate. As a result, the PWM generator creates a high resolution 500 MHz signal using the four 125 MHz clocks.

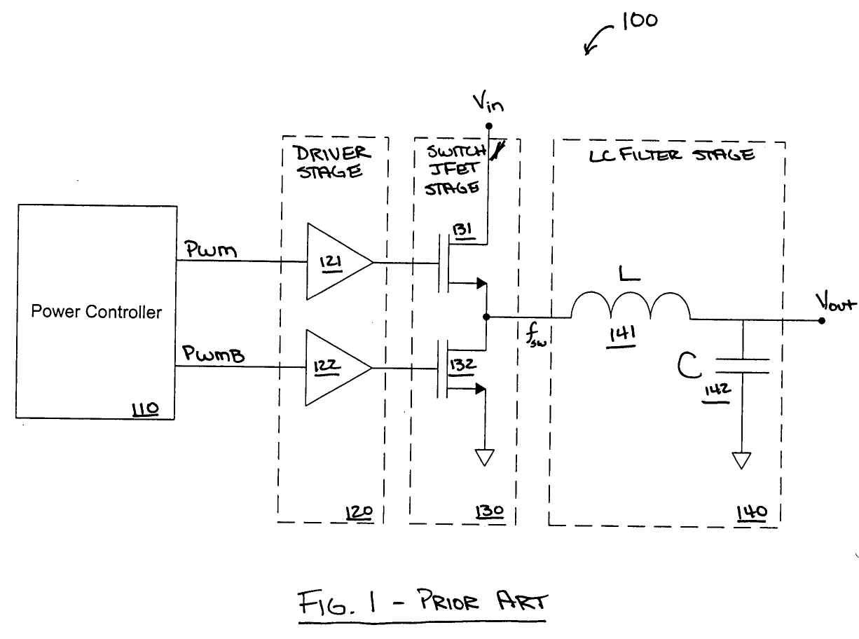

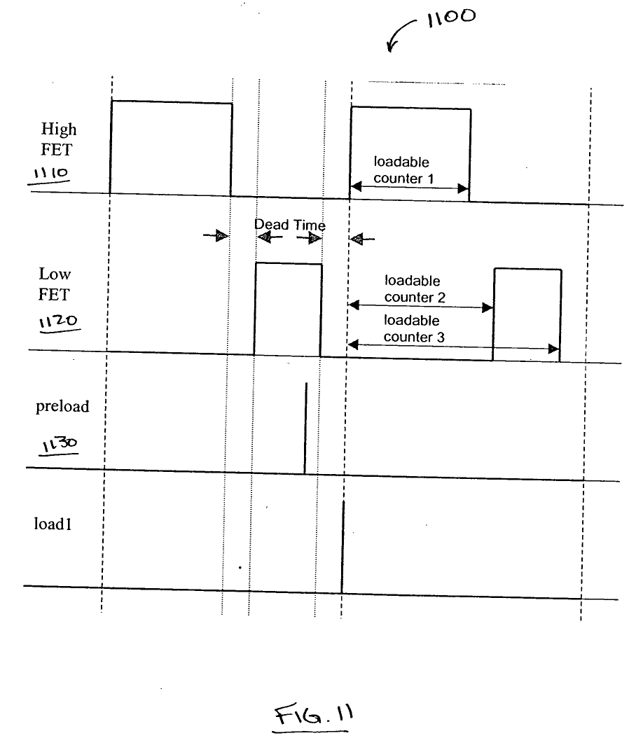

Loadable counters 1020-1040 receive respective data, load, and clock signals from control circuitry 1010. The data loaded into each of the loadable counters relates to the timing of the switching signals provided to a switching stage, such as that in FIG. 1. FIG. 11 illustrates a PWM signal timing diagram in accordance with one embodiment of the present invention. As illustrated in FIG. 11, the switching times for the FETs of a switching stage are controlled by the loadable counter. For example, loadable counter 1020 relates to the duration of the high FET is on, loadable counter 1030 relates to when the low FET is turned on, and the non-overlap time of the FETs, and loadable counter 1040 relates to when the low FET is turned off.

Returning to FIG. 10, each counter is loaded with a data value. In operation, each counter receives the data value and decrements down to zero from the data value. When the zero value is reached by a counter, the counter provides a reset signal to the flip flop set that corresponds to the counter. The flip flops are then reset asynchronously on the next clock count. The selection a particular flip flop with an enable signal may determine on which PLL clock signal you terminate or start the signal. In one embodiment, the enable signal is encoded into the least significant bits of the duty cycle information signal output by the PID regulator. In another embodiment, the enable signal is encoded into the least significant bits of the duty cycle signal output by the DC controller. In either case, the control logic operates to retrieve the enable data and drive the flip flops within the PWM generator.

In FIG. 10, counter 1020 controls the time from zero for which the high FET is turned on. Once the counter has decremented down to zero, the flip flops are reset and the high FET is turned off. Similar to counter 1020, counter 1030 controls the time from zero at which the low FET is turned on. By using NOT gate 1084, the flip flops provide an off signal until the counter decrements to zero. At the point the counter decrements to zero, the flip flops are asynchronously reset. The reset signal is turned on by NOT gate 1084 such that the low FET signal is turned on upon reset. When counter 1040 decrements to zero, it provides an reset signal to the corresponding flip flop set that trigger the end of the low FET on signal. In one embodiment, it may be advantageous to not allow a user to program the exact duration of the low FET because in order to maintain the same switching frequency. The start of the high and low FET signals is triggered by loads generated by the synchronization module 620. Thus, for the embodiment illustrated in FIGS. 10 and 11, load1 indicates at what point the FET signals should be calculated from.

The specific values for counters 1020-1040 can be loaded in numerous ways. In one embodiment, they can be loaded by control circuitry (not specifically illustrated in FIG. 10). One example of this in FIG. 10 is that the dead time, or non-overlap time between the FET high and low signal can be programmed using counter 1030, but must by no less than the value of DT signal received by control logic 1010. In another embodiment, values for the counters can be loaded through the DC signal. In this case, the most significant bits of the DC signal may contain values for up to all of the counters.

A broad range of signal programming is available with the programmable, digital system of the present invention, of which one embodiment is illustrated in FIG. 10. It will be understood by those in art that a broad range of FET on and off patterns may be programmed using the system and method discussed herein, of which FIG. 10 is shown as merely an example.

For example, in another embodiment, one of more of the plurality of PWM generators may generate a single PWM signal rather than a high and low PWM signal. The generated PWM signal may then be received and processed by one or more driver modules external to the digital power controller. The driver module processing may include inverting the PWM signal to generate a PWM signal pair as well as controlling the dead time between the PWM signal pair. Thus, the PWM generators, control circuitry and other components of the digital power controller are flexible in that they may be configured to provide power control signals to be received directly by FETs, by drivers, or by any other device or module in a system for providing power in an electronic device.

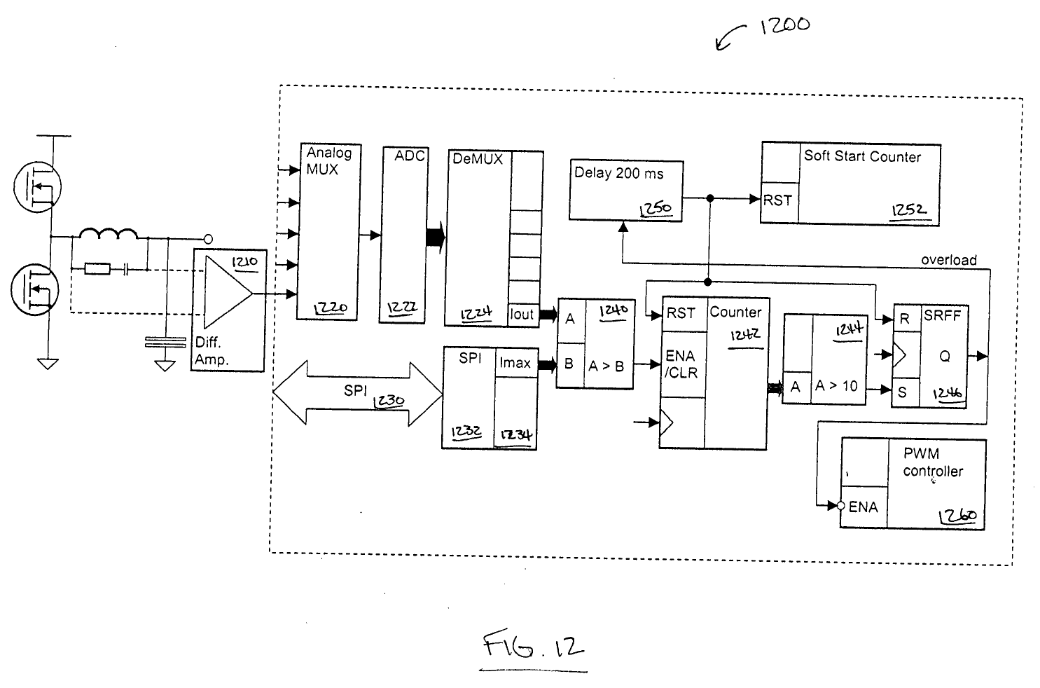

The digital power controller of the present invention may also include circuitry or software for implementing protection and monitoring functions within the controller, as illustrated by protection and monitoring module 460 of FIG. 4. Current protection circuit block 1200 of FIG. 12 illustrates one possible protection circuit that can be implemented in one embodiment of the present invention. In operation, a differential amplifier 1210 senses the current signal at the LC filter. The analog output of the differential amplifier is then received by analog mux 1220, then digitized by ADC 1222. Multiple values of the current are then stored in registers. The registers may be within memory 480 of FIG. 4 or other registers. A threshold value of the current, Imax, is then loaded into a register through an SPI interface 490. The value Imax can be preset or programmed by a user. The measured instances of the current are then compared to the threshold Imax at counter 1240. If the measured current is greater than the threshold current for a number of cycles, as determined by counter 1242 and comparator 1244, an overload flag is set by device 1246. The condition is monitored for a number of cycles, such as ten cycles, to ensure that the measurement is not a glitch. Once the overload flag is set, operation of the PWM generator associated with the high current is temporarily disabled at 1260. In addition to disabling the PWM, a delay is implemented at counter 1250 and 1252 after which the PWM generator is re-started.

As illustrated in FIG. 12, protection and monitoring functions can be applied to different aspects of the digital power controller. The protection and monitoring may be programmed with different thresholds, delays, and other elements as understood by those skilled in the art.

In one embodiment, memory 480 of FIG. 4 may store programming information contained in program signals received through an input means of the IC. In the embodiment illustrated in FIG. 4, the input means is illustrated as an SPI interface. The memory can be used to store accessible information regarding monitored process, logs of the operation of the digital power controller, and information programmed by users and manufacturers. The programming information is accessible and can be stored and retrieved internally by the digital power controller, control circuitry, protection and monitoring circuitry, and other modules of the power controller integrated circuit, as well as externally through an interface such as the serial port interface 490 of FIG. 4. As illustrated, the digital power controller interface is communicatively coupled to the memory and control circuitry 450, as well as external processors or other systems configured to transmit and receive information. The use of a single input means or data interface as well as a single memory, both of which can be used for controlling and monitoring the plurality of PMW signal generators (and other digital power controller modules of FIG. 4), allows for reduced signal processing, power consumption, and space used in the vertically integrated programmable digital power controller of the present invention. Though only an SPI interface is illustrated in FIG. 4, other types of serial and parallel interfaces may be incorporated with the present invention as known by those skilled in the art.

In one embodiment, the power controller of the present invention processes digital signals to generate multiple PWM signals. The power controller is implements a vertical integration of power controllers. The power controller of the present invention is designed to programmable and flexible. As a result, the power controller of the present invention can be used for unlimited numbers of applications and consumer products having diverse power needs. The digital power controller includes protection and monitoring circuitry that can be configured by a user to retrieve information from the power controller as well as manage its operation. In one embodiment, PWM signals are generated from switching frequency signals and a plurality of clock signals, along with an array of digital circuitry for specifying FET switching stage signal characteristics.

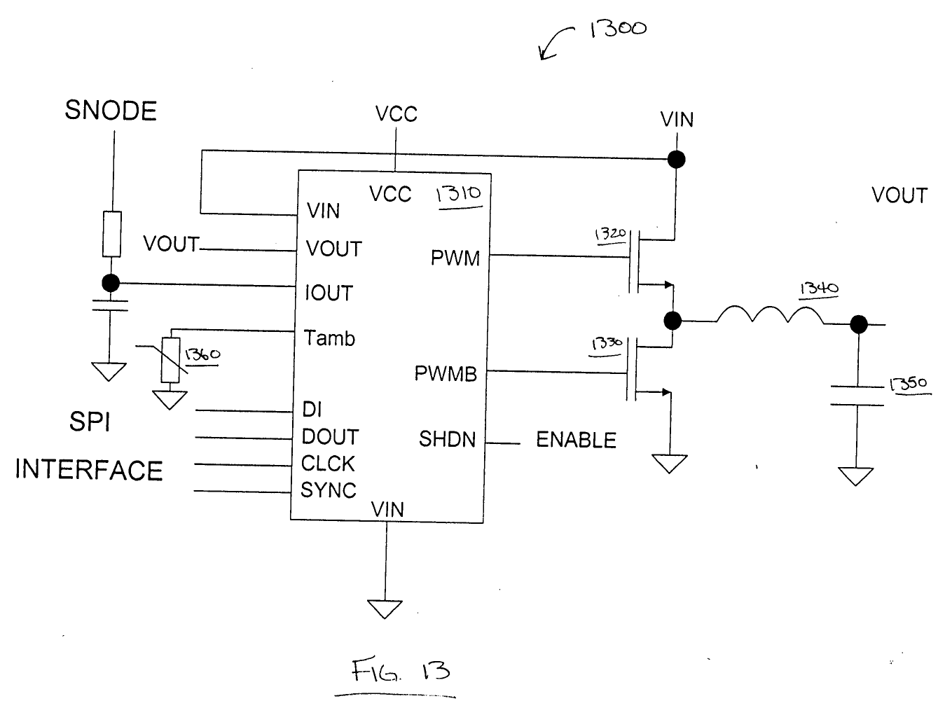

In one embodiment of the present invention, the digital power controller of the present invention can be implemented as an integrated circuit. As such, it may be manufactured using integrated circuit fabrication techniques known in the art. An implementation of a digital power controller integrated circuit 1300 in accordance with one embodiment of the present invention is illustrated in FIG. 13. IC implementation 1300 includes a digital power controller IC 1310, FETs 1320 and 1330, inductor 1340, capacitor 1350, and temperature sensor 1360. IC 1310 receives an input voltage Vin, output voltage Vout, output voltage lout, and outputs PWM signals PWM and PWMB. IC 1310 is also configured to transmit information to and from an SPI interface. The purpose and operation of the signal lines of IC 1310 are discussed above in more detail with reference to FIGS. 4-12.

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In the following description, various aspects of the present invention will be described. However, it will be apparent to those skilled in the art that the present invention may be practiced with only some or all aspects of the present invention. For purposes of explanation, specific numbers, materials, and configurations are set forth in order to provide a thorough understanding of the present invention. However, it will be apparent to one skilled in the art that the present invention may be practiced without the specific details. In other instances, well-known features are omitted or simplified in order not to obscure the present invention.

Parts of the description are presented in data processing terms, such as data, selection, retrieval, generation, and so forth, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through electrical, optical, and/or biological components of a processor and its subsystems.

Various operations are described as multiple discrete steps in turn, in a manner that is most helpful in understanding the present invention, however, the order of description should not be construed as to imply that these operations are necessarily order dependent.

Various embodiments are illustrated in terms of exemplary classes and/or objects in an object-oriented programming paradigm. It will be apparent to one skilled in the art that the present invention can be practiced using any number of different classes/objects, not merely those included here for illustrative purposes. Furthermore, it will also be apparent that the present invention is not limited to any particular software programming language or programming paradigm.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to, a digital programmable power controller.

1. An integrated circuit, comprising:
a plurality of power controllers, each of the plurality of power controllers adapted to generate a pulse width modulation signal and receive control signals, the integrated circuit configured to receive a switching frequency signal and a programming signal and transmit the plurality of pulse width modulation signals; and
a memory, the memory configured to store programming information contained in the programming signal, the control signals derived from the programming information.

2. The integrated circuit of claim 1 wherein the programming signal is received through an SPI interface.

3. The integrated circuit of claim 1 wherein the pulse width modulation signal generated by each power controller is derived from the programming information.

4. The integrated circuit of claim 1 wherein the plurality of power controllers and memory are implemented in digital circuitry.

5. The integrated circuit of claim 1 wherein the pulse width modulation signal generated by at least one of the plurality of power controllers includes a high and low pulse width modulation signal.

6. An integrated circuit, comprising:
a plurality of power controllers, each of the plurality of power controllers adapted to generate a pulse width modulation signal, the integrated circuit configured to receive a switching frequency signal and a programming signal and transmit the plurality of pulse width modulation signals;
a memory, the memory configured to store programming information contained in the programming signal; and
control circuitry, the control circuitry adapted to access the programming information in the memory and adapted to control the plurality of power controllers.

7. The integrated circuit of claim 5 wherein the programming signal is received through an SPI interface.

8. The integrated circuit of claim 5 wherein the control circuitry is further configured to use the programming information to configure the pulse width modulation signal generated by each power controller.

9. The integrated circuit of claim 5 wherein the plurality of power controllers, memory, and control circuitry are implemented in digital circuitry.

10. The integrated circuit of claim 6 wherein the pulse width modulation signal generated by at least one of the plurality of power controllers includes a high and low pulse width modulation signal.

11. A digital power control device implemented on an integrated circuit, comprising:
analog to digital conversion circuitry configured to generate a digital signal from a received analog signal;
regulator circuitry connectively coupled to said analog to digital conversion circuitry, said regulator circuitry configured to receive the digital signal and generate a digital duty cycle information signal;
a plurality of pulse width modulation signal generators, each pulse width modulation signal generator configured to receive the digital duty cycle information signal and generate a pulse width modulation signal; and
control circuitry connectively coupled to and configured to control the plurality of pulse width modulation signal generators.

12. The digital power control device of 11 wherein said regulator circuitry is configured to receive a reference voltage signal, the voltage reference signal generated externally from the integrated circuit.

13. The digital power control device of 11 wherein said plurality of pulse width modulation signal generators are configured to receive a clock signal and a switching frequency signal, the pulse width modulation signal derived from the clock signal, the switching frequency signal, and the digital duty cycle information signal.

14. The digital power control device of 11 further comprising:
synchronization circuitry connectively coupled to said plurality of pulse width modulation signal generators, the synchronization circuitry configured to receive a switching frequency signal and generate a plurality of synchronizing load signals, wherein each pulse width modulation signal generator receives one of the synchronizing load signals.

15. The digital power control device of 11 further comprising:
a programmable memory connectively coupled to the control circuitry, the control circuitry configured to retrieve setting information from the programmable memory.

16. The digital power control device of claim 11 further comprising:
protection circuitry connectively coupled to said analog to digital conversion circuitry, said protection circuitry including circuitry configured to compare a measured voltage level to a programmable threshold level, and perform corrective action if the measured voltage level exceeds the programmable threshold level.

17. The integrated circuit of claim 11 wherein the pulse width modulation signal generated by at least one of the plurality of power controllers includes a high and low pulse width modulation signal.

18. A digital power control system, comprising:
regulator circuitry connectively coupled to said analog to digital conversion circuitry, said regulator circuitry configured to receive the digital signal and generate a digital duty cycle information signal;
a plurality of pulse width modulation signal generators, each pulse width modulation signal generator configured to receive the digital duty cycle information signal and generate a pulse width modulation signal;
control circuitry connectively coupled to and configured to control the plurality of pulse width modulation signal generators;
a programmable memory connectively coupled to the control circuitry; and
an interface connectively coupled to said programmable memory and said control circuitry, the interface configured to receive information signals and route signals to the programmable memory and control circuitry, the information signals containing information to program the digital power control device.

19. A digital power control system for supplying multiple dynamic voltages, comprising:
analog to digital conversion circuitry configured to generate a digital signal from a received analog signal;
regulator circuitry connectively coupled to said analog to digital conversion circuitry, said regulator circuitry configured to receive the digital signal and generate a digital duty cycle information signal;
a plurality of pulse width modulation signal generators, each pulse width modulation signal generator configured to receive the digital duty cycle information signal and generate a pulse width modulation signal, each of the pulse width modulation signals generated as an output of the digital power control device;
control circuitry connectively coupled to and configured to control the plurality of pulse width modulation signal generators;
a programmable memory connectively coupled to the control circuitry; and
an interface connectively coupled to said programmable memory and said control circuitry and configured to receive input signals, the pulse width modulation signals configured to be derived from processing of the input signals by the control circuitry and pulse width modulation signal generators.

20. A digital power control system, comprising:
analog to digital conversion circuitry configured to generate a digital signal from a received analog signal;
regulator circuitry connectively coupled to said analog to digital conversion circuitry, said regulator circuitry configured to receive the digital signal and generate a digital duty cycle information signal;
a plurality of pulse width modulation signal generators, each pulse width modulation signal generator configured to receive the digital duty cycle information signal and generate a pulse width modulation signal; and
control circuitry connectively coupled to and configured to control the plurality of pulse width modulation signal generators.

21. A method for generating a plurality of pulse width modulation power signals from a digital power controller, comprising:
receiving an analog output voltage signal;
transforming the analog output voltage signal into a digital output voltage signal;
generating a digital duty cycle information signal from the digital output voltage signal; and
generating a plurality of pulse width modulation signals from the digital duty cycle information signal by pulse width modulation circuitry, wherein control circuitry is used to control the pulse width modulation circuitry.

22 The method of 21 wherein said generating a digital duty cycle information signal includes:
generating the digital duty cycle information signal from the digital output voltage signal and a reference voltage signal, the reference voltage signal generated externally from the digital power controller.

23. The method of 21 wherein said generating a plurality of pulse width modulation signals includes:
generating a plurality of pulse width modulation signals by processing the digital duty cycle information signal, a clock signal, and switching frequency signal by pulse width modulation circuitry.

24 The integrated circuit of claim 23 wherein the pulse width modulation signal generated by at least one of the plurality of power controllers includes a high and low pulse width modulation signal.

25. The method of 21 further comprising:
comparing the digital output voltage to a threshold voltage; and
taking corrective action within the digital power controller if the digital output voltage exceeds the threshold value.

26. The method of 21 further comprising:
driving the pulse width modulation circuitry by a phase locked loop module, the phase locked loop module generating multiple clock signals, each clock signal having a phase shift.

27. The method of 21 further comprising:
generating a plurality of synchronizing load signals, wherein each synchronizing load signal is used to generate a high and low pulse width modulation signal.

28. The method of 21 wherein the control circuitry is configured to be programmable.

29. The method of 28 wherein the control circuitry includes a programmable memory device.

30. The method of claim 29 wherein data can be retrieved from the programmable memory device.

31. The method of 28 wherein the control circuitry is configured to receive program instructions.

32. The method of 28 wherein one of the plurality of pulse width modulation signals has a different voltage level than at least one other pulse width modulation signals.

33. The method of 28 wherein a first pulse width modulation signal is driven to a first voltage before a second pulse width modulation signal is driven to a second voltage.
